(19) United States
(12) Patent Application Publication
(10) Pub. No.: US 2016/0084449 A1
(43) Pub. Date: Mar. 24, 2016

(54) Tubular LED Lamp

(71) Applicants: Richard Speer, Concord, MA (US); Rodrigo Pereyra, Salem, MA (US); John Selverian, North Reading, MA (US)

(72) Inventors: Richard Speer, Concord, MA (US); Rodrigo Pereyra, Salem, MA (US); John Selverian, North Reading, MA (US)

(73) Assignee: OSRAM SYLVANIA INC., Danvers, MA (US)

(21) Appl. No.: 14/861,315

(22) Filed: Sep. 22, 2015

Related U.S. Application Data
(60) Provisional application No. 62/054,120, filed on Sep. 23, 2014.

(51) Int. Cl. F21K 99/00; F21V 19/00

(52) U.S. Cl. CPC F21K 9/175; F21V 19/0025; F21Y 2103/003

(57) ABSTRACT

There is herein described an LED lamp comprising a thermoformed circuit board and a tubular lamp body having a diffuser. The thermoformed circuit board comprises a substrate, an intermediate circuit board having electrical conductors, and a coverlay laminated to the substrate. The intermediate circuit board and electrical conductors are disposed between the substrate and the coverlay which has openings in which light-emitting diodes (LEDs) are mounted and electrically connected to the electrical conductors of the intermediate circuit board. Each of the substrate and coverlay is comprised of a formable polymer material and the thermoformed circuit board has an elongated shape with an arcuate cross section. Since the thermoformed circuit board has a curvature that can be substantially the same as the curvature of the tubular lamp body, the LED may be located approximately at the circumference of the lamp.

### CROSS REFERENCE TO RELATED APPLICATION

This application claims the benefit of U.S. Provisional Application No. 62/054,120 filed Sep. 23, 2014.

### BACKGROUND OF THE INVENTION

Standard linear fluorescent lamps are one of the most common lamp forms used to generate light. Given the large number of fluorescent fixtures installed in commercial, institutional, and industrial establishments, it is desirable to replace fluorescent lamps with other high efficiency, mercury-free lighting solutions having the same form factor so that replacement of the existing fixtures is not necessary. This has led to the development of solid-state replacement lamps which include linear arrays of light-emitting diodes (LEDs) on circuit boards disposed within hollow tubes.

In conventional linear fluorescent lamps, the light is emitted more or less uniformly around the axis of the tubular bulb. Most current fluorescent fixtures are designed to account for this uniform light distribution. On one hand, LEDs have an advantage in that the light can be directed and more of it can be directed downward which may reduce some of the losses associated with light reflecting around within the fixture. One the other hand, the directional nature of the LEDs makes it difficult for light to reach the reflecting surface of the fixture which may cause portions of the fixture to appear dark.

FIG. 1 illustrates a typical LED lamp retrofit solution 100 for a conventional linear fluorescent lamp, in particular a T8 fluorescent lamp. (The diameters of conventional linear fluorescent lamps are expressed in eighths of an inch, wherein a T5 lamp has a ⅝ inch diameter, a T8 lamp has a 1 inch diameter, and a T12 lamp has a 1½ inch diameter.) The typical retrofit solution includes a rigid circuit board 112 that is mounted to a length of an extruded aluminum heatsink 110 which is disposed inside a plastic tube having an opaque portion 104 and a translucent portion that serves diffuser 106. The LEDs 108 direct light 116 out through the translucent diffuser 106 of the plastic tube. After passing through the translucent diffuser 106 light 118 exits the front 122 of lamp 100. However, no light can pass out of the back 124 of lamp 100 and onto the reflecting surface 132 of fixture 130 due to circuit board 112 and aluminum extrusion 110.

There are two main challenges with this configuration. The first is the appearance of bright spots of light when viewing the tube directly. This is caused by the location of the LEDs near the center of the lamp which provides for less distance between the LEDs 108 and the diffuser 106. The second is the loss of light due to backscattered light rays which are not reflected forward by the circuit board or aluminum extrusion.

As these challenges are mainly related to the limitations placed on the design of the lamp by the rigid circuit board and its associated aluminum heatsink, it would be desirable to have more versatile and less costly materials for use in the circuit boards of LED retrofit lamps. More particularly, it is desirable to have a circuit board material that can be used for applications where conventional resin-impregnated fiberglass circuit boards, such as FR4 boards, are impractical.

### SUMMARY OF THE INVENTION

It has been found that a flexible, formable polymer material such as polyethylene terephthalate (PET) may be used to form circuit boards. Conductive traces can be applied to a PET material with various techniques including, screen printing, lithography and etching, or copper ribbon lamination. In particular, it has been found that PET can be used to create thermoformed circuit boards for use in tubular LED retrofit lamps designed as replacements for liner fluorescent lamps. A significant advantage of the thermoformed circuit boards is that unlike FR4-based printed circuit boards, an extruded aluminum frame is not required to hold the circuit board.

Thus, in accordance with one aspect of the invention, there is provided an LED lamp comprising a thermoformed circuit board and a tubular body having a diffuser. The thermoformed circuit board is comprised of a substrate, an intermediate circuit board having electrical conductors, and a coverlay laminated to the substrate wherein the intermediate circuit board and electrical conductors are disposed between the substrate and the coverlay. The coverlay has openings in which light-emitting diodes (LEDs) are mounted and electrically connected to the electrical conductors of the intermediate circuit board. Each of the substrate and coverlay are comprised of a formable polymer material and the thermoformed circuit board has an elongated shape with an arcuate cross section.

### BRIEF DESCRIPTION OF THE DRAWINGS

Features and advantages of various embodiments of the claimed subject matter will become apparent as the following Detailed Description proceeds, and upon reference to the Drawings, wherein like numerals designate like parts, and in which:

FIG. 1 is a cross-sectional illustration of a prior art retrofit solution for a linear fluorescent lamp application.

FIGS. 2A and 2B are cross-sectional illustrations of embodiments of the tubular LED lamp of this invention wherein the thermoformed circuit board is contained within, and alternately forms a part of, the tubular lamp body, respectively.

FIGS. 3A and 3B compare two different circuit board configurations, a thin board and wide board, respectively.

FIGS. 4A-4C are sets of perspective and end views that illustrate the construction of a thermoformed circuit board for use in the tubular LED lamp of this invention.

FIG. 5 is a cross-sectional illustration of another embodiment of a tubular LED lamp according to this invention mounted in a fluorescent lamp fixture.

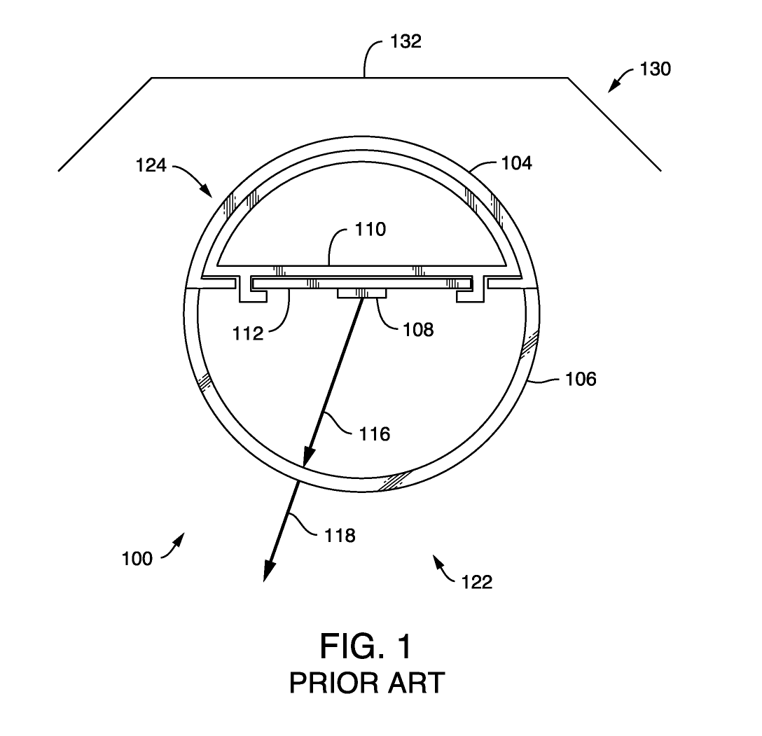

### DETAILED DESCRIPTION OF THE INVENTION

Thermoformed PET-based circuit boards have been applied to make circuit boards for T8-LED tubular light sources. (Here, T8 refers to the conventional fluorescent lamp designation for diameter. A T8 fluorescent lamp has a 1 inch diameter.) One useful configuration includes a laminated copper/PET that is etched and covered with a highly reflective PET. Such a configuration is formable and may be used for the T8 form factor.

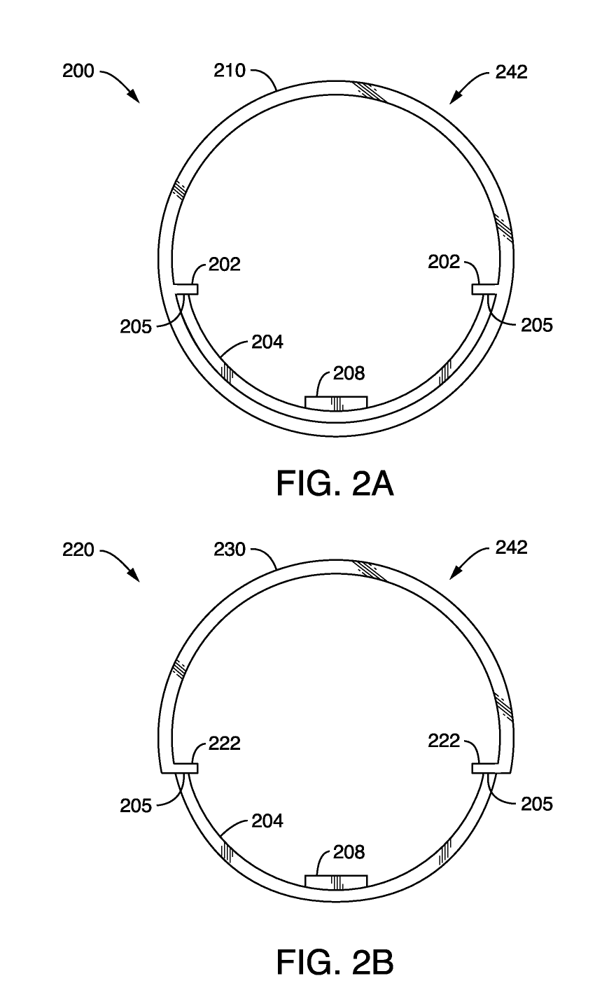

Referring now to FIG. 2A, there is shown a cross-sectional illustration of a first embodiment of a tubular LED lamp 200 according to this invention. The tubular body 210 encloses an elongated, thermoformed circuit board 204 having an arcuate cross section. The curvature of the circuit board 204 is substantially the same as the curvature of the tubular body 210 so that the LEDs 208 mounted on the circuit board reside approximately at the circumference of lamp 200. The circuit board 204 is held in place by two longitudinal ridges 202 that extend the length of the tubular body 210 and engage the longitudinal edges 205 of circuit board 204. The increased distance of the LEDs 208 from the front 242 of lamp 200 helps with diffusion and light distribution. The portion of tubular body 210 between ridges 202 and opposite circuit board 204 is translucent and functions as a diffuser so that a diffuse light is emitted from the front 242 of lamp 200.

FIG. 2B is a cross-sectional illustration of another tubular LED lamp according to this invention. The lamp 220 is similar to the lamp shown in FIG. 2A except that the circuit board 204 forms a part of the tubular body of the lamp. In particular, the tubular body is formed by mating a translucent diffuser 230 in the form of a partial tube with the curved circuit board 204. The diffuser 230 is mated to the circuit board 204 by attaching the longitudinal edges 205 of the circuit board 204 to longitudinal flanges 222 that extend the length of diffuser 230. Both the diffuser and the circuit board have a cross sectional curvature that comprises a circular arc and, when mated, form a tubular lamp body with a substantially circular cross section. In either embodiment, the lamp body may be fitted with conventional fluorescent bi-pin ends caps (not shown) to provide an electrical interface that is compatible with existing fluorescent lamp fixtures. Additional electronics may also be provided within the tube or attached to one or both ends of the tube to provide AC-to-DC power conversion, current regulation, etc.

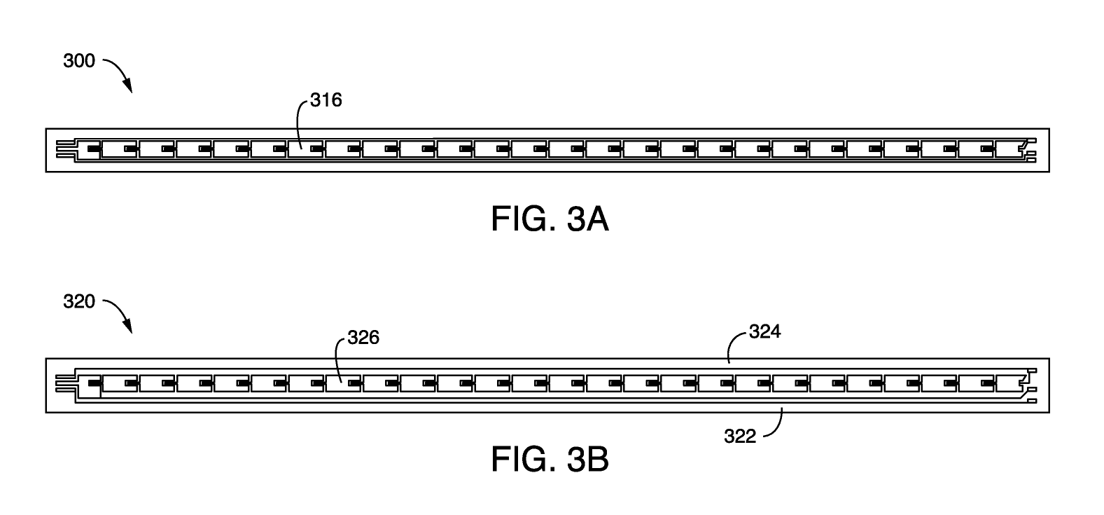

FIGS. 3A and 3B illustrate examples of circuit boards that may be used with a tubular LED lamp. In particular, FIGS. 3A and 3B show formed thin (Thin Board) 300 and wide (Wide Board) 320 circuit boards, respectively, each having a pattern of etched copper conductors 316, 326 on their surface. Essentially the same circuit pattern is used in both cases. The Wide Board version allows for a coverlay (not shown) of highly reflective white PET to be laminated directly to circuit board 320 along its edges 322, 324 where the copper has been etched away. The coverlay has holes which expose portions of the copper conductors 326 corresponding to the locations where the LEDs will be attached prior to thermoforming. However, although the Wide Board with its overlapping PET/PET layer structure (i.e., regions where there is no copper between sheets) seems to assist in maintaining the integrity of the thermoformed board, more copper must be etched away leading to extra cost. Thus, the Thin Board is preferred for its better utilization of copper. Moreover, its thermal performance for T8 form factors was determined to be sufficient.

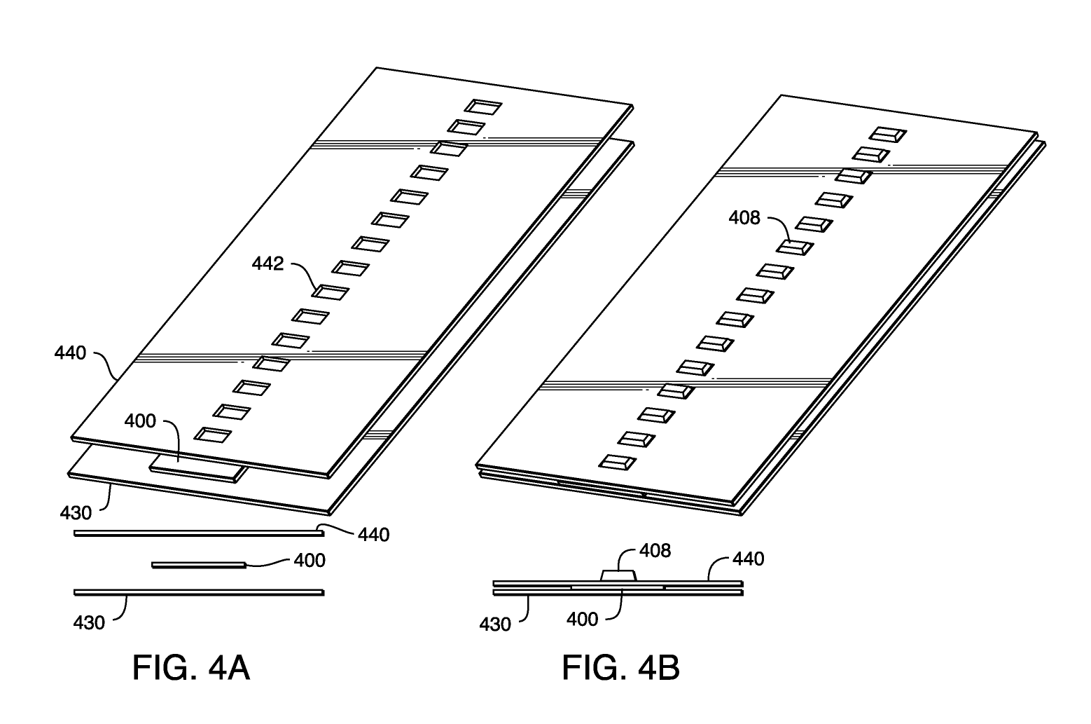

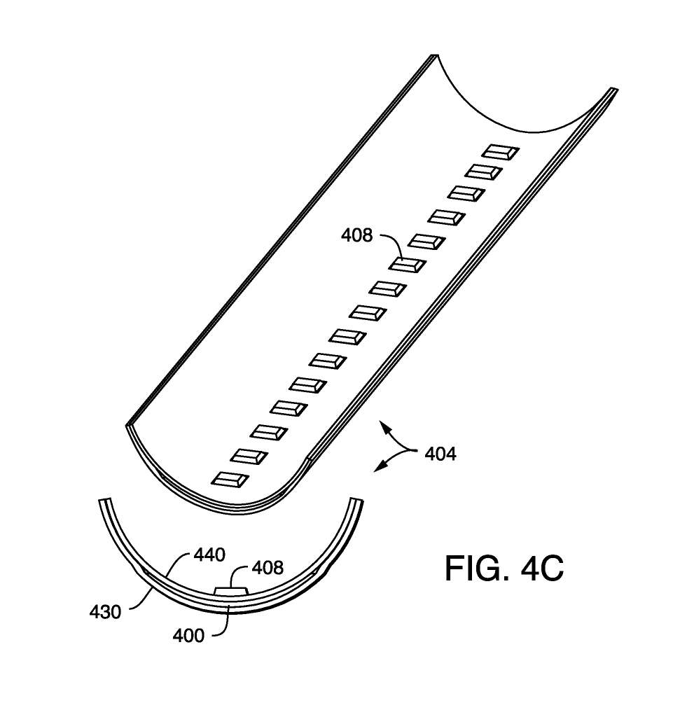

With reference to FIGS. 4A-4C, there is shown a Thin Board circuit board construction that has a higher utilization of laminated copper yet has the formed integrity of the Wide Board. In this embodiment, the thin circuit board 400 is laminated between two pieces of PET, coverlay 440 and substrate 430. The coverlay 440 is preferably a white PET with a high reflectivity (>90%) and has openings 442 corresponding to the locations of LEDs 408. The substrate 430 may be either white or clear PET. With reference to FIG. 4A, after the circuit board 400 has been laminated between the coverlay 440 and substrate 430, the circuit board 400 can be populated with LEDs 408 using a solder paste and a solder reflow process. Preferably, the solder paste contains a low temperature Bi/Sn solder and reflow is performed by heating the circuit board at about 140° C. Alternately, the LEDs 408 may be attached to the circuit board 400 prior to lamination as shown in FIG. 4B. In either case, the flat laminated circuit board assembly is then thermoformed by heating the assembly in a mold (preferably at about 110° C.) to form thermoformed circuit board 404 having an arcuate cross section. Preferably, the cross section of thermoformed circuit board 404 is a circular arc which subtends a central angle of 120° to 150°.

The above embodiment allows for optimizing the circuit pattern for the operation both electrical and thermal performance of the light engine, while maintaining the dimensions of the formed body for mechanical and optical requirements. Clearly, when smaller amounts of copper are etched away there is a savings in raw material cost as well as hazardous waste disposal and chemicals usage. While a PET-based circuit board is preferred, it is also possible for circuit board 400 to comprise a thin rigid circuit board such as an FR-4 board.

As mentioned above, the directional distribution of the light from LEDs in retrofit lamps may be a drawback if the lamp is substituted directly into a fluorescent lamp fixture that was designed to take full advantage of the 360° axial light emission of a linear fluorescent lamp. In such cases, the retrofit lamp may cause portions of the fixture to appear dark as the light may be emitted from the lamp at a lesser central angle, e.g., 220°.

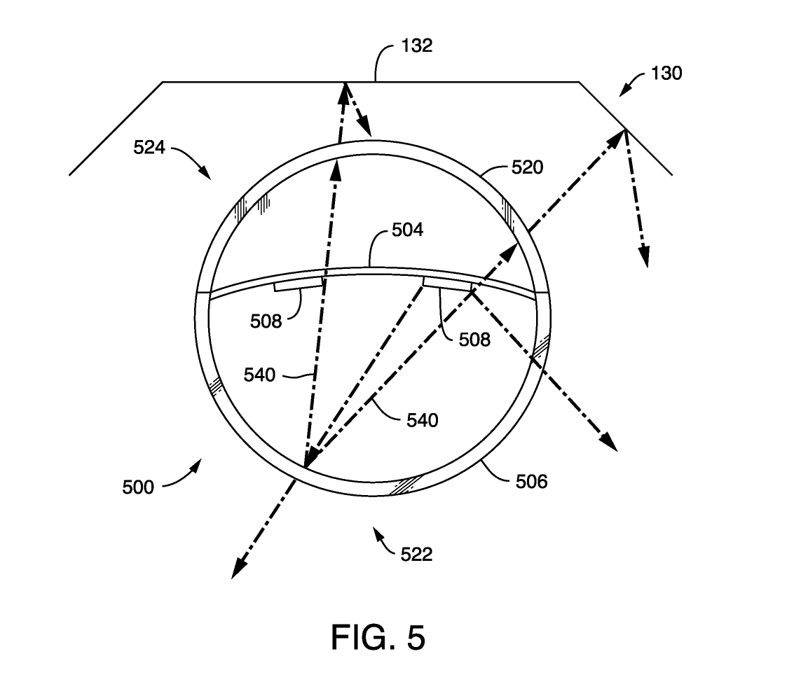

In order to provide a more uniform light distribution, another embodiment of the invention is shown in FIG. 5 in which the LEDs 508 are mounted to a thermoformed circuit board 504 which may be comprised partially or entirely of either a translucent or fully transparent formable polymer, such as PET or partially filled PET. Here the thermoformed circuit board 504 is mounted more centrally within the tubular body which is comprised of diffuser 506 and rear portion 520, both of which are translucent. By varying the translucency of the circuit board 504, including using transparent materials, the amount of the reflected light 540 that is transmitted through rear portion 520 and out the back side 524 of lamp 500 may be controlled to a desired degree. In general, approximately 20-30% of the light incident on the inside surface of diffuser 506 on the front side 522 of lamp 500 will be reflected back towards the reflecting surface 132 of fixture 130. In an alternate embodiment, the inside surface of the diffuser 506 could also be made partially reflective to reflect more light back towards the thermoformed circuit board 504 and the reflecting surface 132 of fixture 130. Preferably, the partially reflective surface reflects more than about 30% of the incident light and more preferably between about 40% to about 70% of the incident light.

While there have been shown and described what are at present considered to be preferred embodiments of the invention, it will be apparent to those skilled in the art that various changes and modifications can be made herein without departing from the scope of the invention as defined by the appended claims.

What is claimed is:

1. An LED lamp comprising a thermoformed circuit board and a tubular body having a diffuser and;
the thermoformed circuit board comprising a substrate, an intermediate circuit board having electrical conductors, and a coverlay laminated to the substrate, the intermediate circuit board and electrical conductors being disposed between the substrate and the coverlay, the coverlay having openings in which light-emitting diodes (LEDs) are mounted and electrically connected to the electrical conductors of the intermediate circuit board;
each of the substrate and coverlay being comprised of a formable polymer material; and
the thermoformed circuit board having an elongated shape with an arcuate cross section.

2. The LED lamp of claim 1 wherein the formable polymer material is polyethylene terephthalate (PET).

3. The LED lamp of claim 1 wherein the coverlay is a highly reflective white PET.

4. The LED lamp of claim 1 wherein the substrate and coverlay are selected from a translucent formable polymer material and a transparent formable polymer material.

5. The LED lamp of claim 1 wherein a curvature of the thermoformed circuit board is substantially the same as a curvature of the tubular body.

6. The LED lamp of claim 1 wherein the intermediate circuit board is comprised of a formable polymer material.

7. The LED lamp of claim 1 wherein the intermediate circuit board comprises a rigid circuit board that is thinner than the substrate and coverlay.

8. The LED lamp of claim 1 wherein the thermoformed circuit board is enclosed within the tubular body of the lamp.

9. The LED lamp of claim 1 wherein the thermoformed circuit board forms a part of the tubular body of the lamp.

10. The LED lamp of claim 1 wherein the thermoformed circuit board has a curvature that is substantially the same as a curvature of the tubular body of the lamp and the LEDs are located approximately at a circumference of the tubular body.

11. The LED lamp of claim 1 wherein the thermoformed circuit board has a curvature that is different from a curvature of the tubular body of the lamp and is mounted centrally within the tubular body.

12. The LED lamp of claim 11 wherein the substrate and coverlay are selected from a translucent formable polymer material and a transparent formable polymer material.

13. The LED lamp of claim 1 wherein the arcuate cross section is a circular arc which subtends a central angle of 120° to 150°.

14. The LED lamp of claim 9 wherein the lamp has a translucent diffuser in a form of a partial tube that is mated to the thermoformed circuit board at its longitudinal edges to form the tubular body.

15. The LED lamp of claim 4 wherein an inside surface of the diffuser is partially reflective and reflects at least about 30% of incident light.

16. The LED lamp of claim 15 wherein the inside surface reflects between about 40% to about 70% of incident light.
